(19) United States
(12) Patent Application Publication
(10) Pub. No.: US 2008/0187827 A1
(43) Pub. Date: Aug. 7, 2008

(54) WELDING-TYPE FIXING CAP AND CELL MODULE EQUIPPED WITH THE SAME

(76) Inventors: Tae-yong Kim, Suwon-si (KR); Dae-won Han, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/951,231

(22) Filed: Dec. 5, 2007

(30) Foreign Application Priority Data
Feb. 2, 2007 (KR) 10-2007-11239

(51) Int. Cl. H01M 2/04; H01M 6/42

(52) U.S. Cl. 429/177; 429/159

(57) ABSTRACT

Disclosed is a welding-type fixing cap used for attachment to both ends of a cylindrical battery composed of metal materials. The welding-type fixing cap comprises a ring-shaped side wall; a visor surface extending outwards from one end of the side wall; a welding lug formed on the visor surface, wherein the welding lug is meltable in a welding process; a cutting hole formed in the side wall, wherein the cutting hole is dimensioned and configured for discharging gas. The welding lug is positioned distal to the side wall and proximal to a cutting hole. The welding-type fixing cap has a sufficient strength, while recuding electric current leakage during a contact-resistance welding.

### CROSS-REFERENCE TO RELATED APPLICATIONS

This application claims the benefit of Korean Patent Application No. 10-2007-11239, filed on Feb. 2, 2007, in the Korean Intellectual Property Office, the disclosure of which is incorporated herein by reference in its entirety.

### BACKGROUND

1. Technical Field

The present disclosure relates generally to batteries, and more particularly, to fixing caps weldable to both ends of a cylindrical battery, which are useful for assembling cell modules comprising a plurality of cylindrical batteries.

2. Discussion of Related Art

Cylindrical structures are used in a wide range of products encountered daily, for example as gas-pressure containers such as freon gas containers, butane gas canisters, oxygen tanks, etc., and in electric energy storage systems such as alkaline batteries, nickel-metal hydride cells, etc. Cylindrically-shaped batteries are easy to produce with desired capacities, and therefore, cylindrical batteries have been used as unit cells.

In order to obtain sufficient voltage and/or electric current, a plurality of cylindrical unit cells are generally connected in series and/or in parallel to form a cell module, which provides a sustained output of a desired voltage and/or current. Generally a plurality of cylindrical batteries is mounted in a case comprising one or more mounting grooves formed therein. Fixing caps are secured to both ends of the plurality of cylindrical batteries so as to fit into the mounting grooves, followed by assembling the plurality of the cylindrical batteries into the case. Here, each of the cylindrical batteries may be one unit cell or a cylindrical tandem battery comprising a plurality of unit cells coupled in series.

The fixing cap should have a sufficient thickness to maintain mechanical integrity, but not too great a thickness, which permits a significant proportion an electric current during welding leaks out through the fixing cap rather than passing to the external wall of the battery, resulting in a poor quality weld.

### SUMMARY OF THE INVENTION

Accordingly, some embodiments disclosed herein solve one or more drawbacks, for example, providing a welding-type fixing cap exhibiting sufficient strength and/or reduced electric current leakage during contact-resistance welding to a battery, and a cell module comprising with the same.

Also, other embodiments provide a welding-type fixing cap which is suitable for manufacturing a cell module comprising a plurality of cylindrical batteries connected in series and/or in parallel, and a cell module equipped with the same.

One embodiment provides a welding-type fixing cap comprising a ring-shaped side wall; a visor surface extending outwards from one end of the side wall, wherein a welding portion, which is melted during a welding process, is formed in the visor surface, a cutting hole for discharging an internal gas formed in the side wall, and the welding portion is positioned in an external region of the side wall in which the cutting holes are present. In some embodiments, a line from a center point of the welding portion vertical to the visor surface intersects at least a portion of the cutting area.

Another embodiment provides a cell module comprising of a frame having a plurality of mounting holes formed therein; and a cylindrical battery having a fixing cap welded to each end, each fixing cap being coupled with a mounting hole, wherein the fixing cap comprises a side wall contacting the mounting hole and comprising cutting holes for discharging an internal gas, formed therein; and a visor surface contacting the cylindrical battery and comprising a welding portion formed therein in an external region of the side wall in which the cutting holes are present, the welding portion being melted during a welding process.

Some embodiments provide a welding-type fixing cap and a cell module comprising a frame comprising a plurality of mounting holes formed therein; and a cylindrical battery comprising a first end and a second end, and a fixing cap welded to each of the first end and the second end, wherein each fixing cap is coupled with a mounting hole.

Some embodiments provide a welding-type fixing cap comprising: a ring-shaped side wall; a visor surface extending outward from one end of the side wall; a welding lug formed on the visor surface and operable to be melted during a welding process; and a cutting area formed in the side wall, and dimensioned and configured for discharging an internal gas, wherein a line through a center point of the welding lug and normal to the side wall intersects at least a portion of a cutting area.

In some embodiments, at least two welding lugs are formed on the visor surface distal to the side wall. In some embodiments, the welding lug is operable and configured for welding using a contact resistance welding.

In some embodiments, a cutting groove is formed in the visor surface, which increases resistance between neighboring welding lugs.

Some embodiments further comprise a welding lug-surrounding region formed on the visor surface and substantially centered above the welding lug, wherein the welding lug-surrounding region is thinner than the adjacent visor surface.

In some embodiments, a gap between the cutting area and the visor surface is about 2 mm or less, and circumferential length of the cutting areas in the side wall comprise from about 40% to about 60% of the total circumferential length of the side wall. In some embodiments, an exterior common tangent line between a boundary surface of the cutting area and a boundary surface of the welding lug forms an angle of from about 20° to about 60° with a line normal to the visor surface passing through the center of the cutting area.

Some embodiments further comprise a base wall closing the other end of the side wall. In some embodiments, a connection hole is formed in a central region of the base wall, dimensioned and configured to receive an external linear structure for coupling with a cylindrical structural body. In some embodiments, a screw thread is formed in an inner wall of the connection hole to couple the linear structure.

In some embodiments, two tangent lines are tangent to each of the cutting holes on the side wall and substantially normal to the visor surface, two emission lines on the visor surface are normal to the side wall, each emission line intersecting a tangent line, and the welding lug is formed between the two emission lines.

### BRIEF DESCRIPTION OF THE DRAWINGS

These and/or other aspects and advantages will become apparent and more readily appreciated from the following description of certain preferred embodiments, taken in conjunction with the accompanying drawings.

FIG. 1A is a cross-sectional side view of a cylindrical battery coupled to an embodiment of a fixing cap.

FIG. 1B is a perspective view of the cylindrical battery and fixing cap of FIG. 1A installed in a frame.

FIG. 2A is a perspective view of an embodiment of a welding-type fixing cap.

FIG. 2B is a side view of an embodiment of a welding-type fixing cap.

FIG. 2C is a side view schematically showing certain proportions of a cutting area of the welding-type fixing cap of FIG. 2A.

FIG. 2D is a top partial cross-sectional view of the welding-type fixing cap of FIG. 2A.

FIG. 3A is a perspective view schematically showing a leakage channel for an electric current in an embodiment of a welding-type fixing cap.

FIG. 3B is a perspective view schematically showing a leakage channel for an electric current in another embodiment of a welding-type fixing cap.

FIG. 3C is a cross-sectional detail view of the welding lug-surrounding region in the welding-type fixing cap of FIG. 2A.

FIG. 4 is a perspective view of an embodiment of a configuration of a cell module in which an embodiment of a welding-type fixing cap is welded to a cylindrical battery.

### DETAILED DESCRIPTION OF CERTAIN EMBODIMENTS

Hereinafter, some preferred embodiments will be described with reference to the accompanying drawings. When a first element is connected and/or coupled to a second element, the first element may be not only directly connected and/or coupled to the second element, but also indirectly connected and/or coupled to the second element through one or more other elements. Elements not related to the features of interest are omitted for clarity. Like reference numerals refer to like elements throughout.

Relative positions of and/or proportions between components are described with reference to lines and/or surfaces indicated in some of the drawings. The relationships between the components, lines, and/or surfaces are based on the two-dimensional orientation illustrated in the referenced drawing and does not refer to a three-dimensional relationship between the components, lines, and/or surfaces.

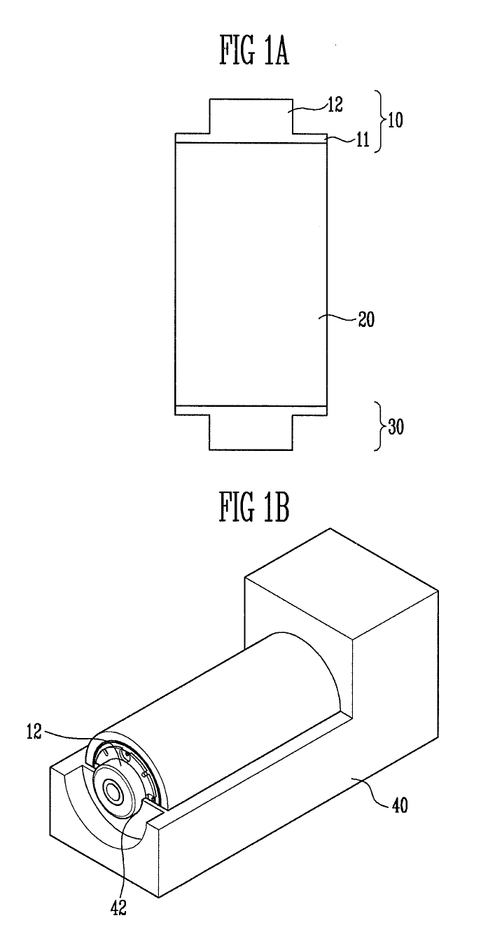

An embodiment of a case and a cylindrical battery using a fixing cap are shown in FIGS. 1A and 1B. FIG. 1A is a view of a cylindrical battery 20 on which is mounted at both ends fixing caps 10 and 30, each comprising a dish-shaped joint 12 formed formed on the end and configured to easily fit into a mounting coupler 42 of the case 40 (FIG. 1B). In embodiments in which an external wall of the cylindrical battery 20 comprises metal materials and the fixing caps 10 and 30 comprise metal materials, contact-resistance welding, is a convenient and economical method for coupling the fixing caps 10 and 30 to the ends of the battery 20.

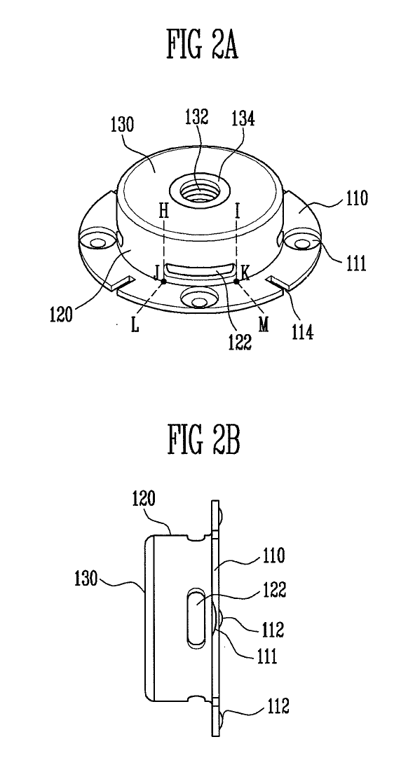

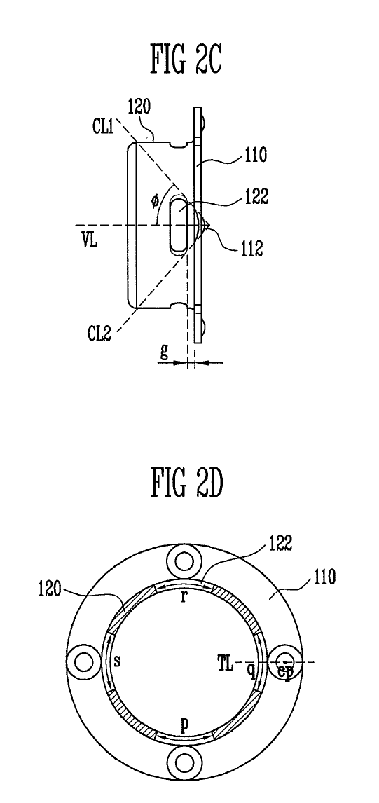

FIG. 2A is a perspective view of an embodiment of a welding-type fixing cap. FIG. 2B is a side view, FIG. 2C is another side view, and FIG. 2D is a partial cross-sectional top view of the embodiment of FIG. 2A. As can be seen in FIG. 2A, the welding-type fixing cap has a cap shape, and comprises a ring-shaped side wall 120; a base wall 130 closing one end of the side wall 120; and a visor surface 110 extending outwards from the other end of the side wall 120, generally normal to the side wall 120 in the illustrated embodiment. A connection hole 132, dimensioned and configured for coupling an external linear structure to the welding-type fixing cap may be formed in a central region of the base wall 130. A screw thread 134 may be formed in an inner wall of the connection hole 132 as illustrated in FIG. 2A, which is useful in coupling the linear structures. Examples of external linear structures include power lines useful for connecting a battery in series and/or in parallel with one or more other cylindrical batteries.

As illustrated in FIG. 2B, a welding lug or portion 112 for contact-resistance welding is formed on the visor surface 110 on a surface opposite from the side wall 120. In a contact-resistance welding process, a welding rod is contacted with point on the visor surface 110 opposite to the welding lug 112. Then, a potential is applied to the welding rod causing an electric current to flow therefrom through the welding lug 112 to a point on an external wall of the cylindrical battery in direct contact with the welding lug 112. Contact resistance between the welding lug 112 and the external wall of the battery melts a portion of the welding lug 112, thereby forming a weld therebetween.

Returning to FIG. 2A, a welding lug-surrounding region 111 may be formed on the visor surface 110 on the opposite face as the welding lug 112. In the illustrated embodiment, the welding lug-surrounding region 111 is generally circular and centered on the welding lug 112. Those skilled in the art will understand that other arrangements are used in other embodiments. The welding lug-surrounding region 111 is thinner than the adjacent portion of the visor surface 110 in the illustrated embodiment. As will be discussed in greater detail below, thinning the welding lug-surrounding region 111 increases the electrical resistance of the region, which improves the welding process.

To increase resistance of the welding-type fixing cap between the welding lugs 112, cutting grooves 114 may be formed in the visor surface 110 between two neighboring welding lugs 112, thereby reducing current flow to the neighboring, previously-welded welding lugs 112 during the welding process.

In the embodiment illustrated in FIGS. 2A and 2B, a cutting area 122 is formed in the side wall 120. In the illustrated embodiment, the cutting area 122 has a generally rectangular shape with rounded corners. The cutting area 122 permits the discharge of gases generated by the cylindrical battery, for example, generated in welding a nickel-metal hydride battery, compressed gas generated by damage to a lithium-ion battery, etc.

FIG. 2A also illustrates a geometric relationship between the cutting area 122 and the welding lug 112. Two tangent lines H and I on the side wall 120 are tangent to the ends of each cutting area 122, and normal to the visor surface 110. Each tangent line H and I intersects an emission line L and M, respectively, extend on the visor surface 110 normal to the side wall 120. The welding lug 112 is disposed between the emission lines L and M.

In a preferred embodiment illustrated in FIG. 2C, the cutting area 122 is formed so that a vertical line VL generally bisecting the welding-type fixing cap through the center of the cutting area 122 also intersects the welding lug 112. Exterior common tangent lines CL1 and CL2 defined by a boundary surface of the cutting area 122 and a boundary surface of the welding lug 112 form an angle φ with the vertical line VL. The angle φ between the vertical line VL and the exterior common tangent lines CL1 and CL2 is from about 20° to about 60°, preferably from about of 25° to about 35°. In some embodiments, a narrower angle leads to poor welding performance, while a wider angle leads to reduced mechanical strength of the fixing cap.

Referring to FIGS. 2C and 2D, in some embodiments, a distance g between the cutting area 122 and the visor surface 110 (FIG. 2C) is about 2 mm or less, and the total sum (p+q+r+s) (FIG. 2D) of circumferential lengths of all of the cutting areas 122 is from about 40% to about 60% of the entire circumferential length of the side wall 120.

In the illustrated embodiment, a line TL drawn on the visor surface 110, normal to the side wall 120, and through a center point cp of the welding lug 112 intersects at least a portion of the cutting area 122, as shown in FIG. 2D. Accordingly, in some embodiments, a welding lug 112 is formed on a portion of the visor surface 110 that is distal to the side wall 120 and proximal to a cutting area 122.

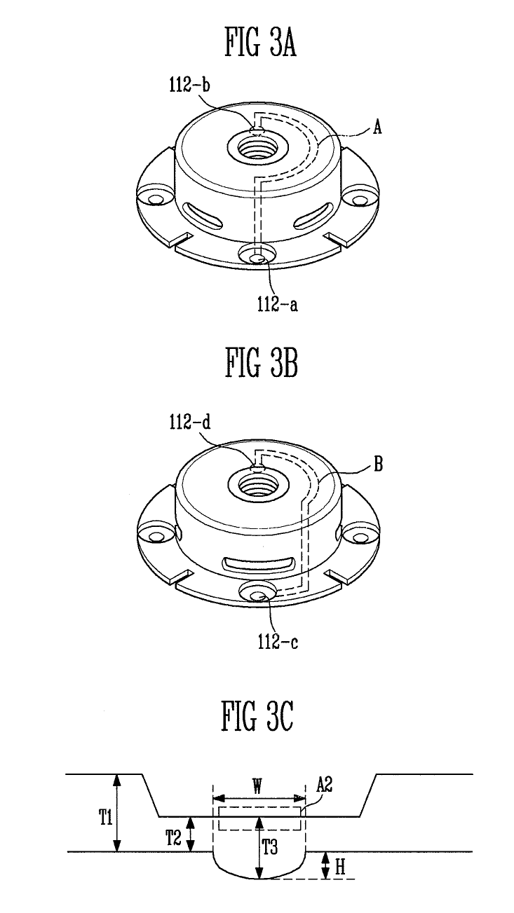

FIGS. 3A and 3B schematically illustrate the increase in resistance due to the presence of the cutting area 122. FIG. 3A shows a welding-type fixing cap in which the cutting area is not disposed as described above and illustrated in FIGS. 2A-2D. As shown in FIG. 3A, an electric current channel between two facing welding lugs 112-a and 112-b is represented by A. Resistance in the channel A is low because the channel A is relatively thick and wide. Accordingly, during the welding of the welding lug 112-a, a significant portion of the electric current from the welding rod leaks through previously welded welding lugs, for example, the welding lug 112-b, resulting in a deterioration in welding performance.

In contrast, an electric current channel B between two facing welding lugs 112-c and 112-d is illustrated in FIG. 3B. Resistance in the channel B is higher relative to channel A (FIG. 3A) because the width is thinner and the channel is longer due to the presence of the cutting area 122. Accordingly, the leakage of the electric current supplied from the welding rod during the welding process through the previously welded facing welding lugs is reduced, resulting in improved welding performance.

FIG. 3C schematically illustrates a cross-section of a portion of a visor surface 110, which provides increased resistance due to the presence of a welding lug-surrounding region 111. As shown in FIG. 3C, a thickness T2 of the welding lug-surrounding region 111 is thinner than a thickness T1 of the adjacent visor surface 110. In this case, the resistance in the welding lug-surrounding region 111 is increased in proportion with the reduced thickness, and therefore the leakage of electric current from the welding rod through the visor surface 110 is reduced.

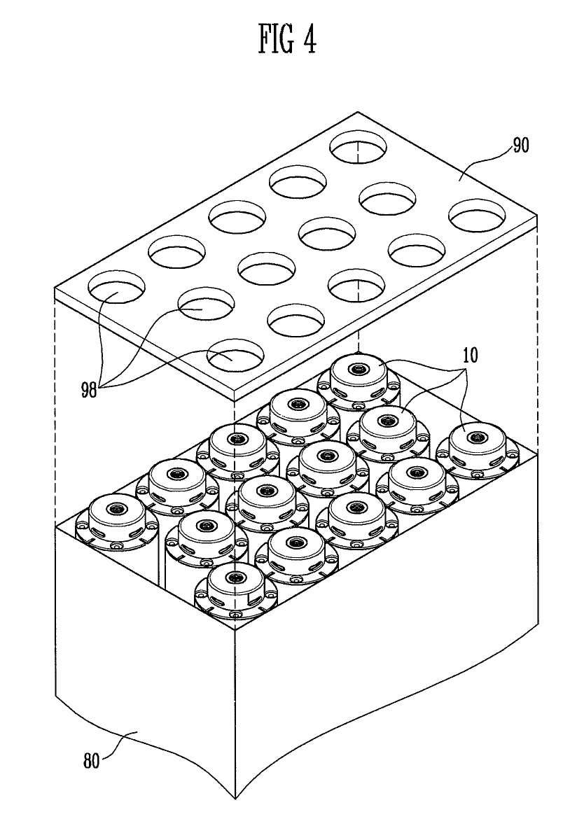

FIG. 4 shows in perspective an embodiment of a cell module in which a plurality of cylindrical batteries, to which an embodiment of the welding-type fixing cap 10 is coupled, is mounted in a case 80. Here, each of the plurality of cylindrical batteries may be one unit cell, and/or a cylindrical tandem battery comprising a plurality of unit cells is coupled in series. The fixing caps 10 are attached to both ends of each of the cylindrical batteries using, for example, a contact-resistance welding process as discussed above. Generally round mounting holes 98 are formed in an upper lid 90 and a lower bottom (not shown) of the case 80. The plurality of the cylindrical batteries may be mounted in the case 80 by fitting dish-shaped joints of the fixing caps 10, into the mounting holes 98. After the plurality of cylindrical batteries is mounted in the case 80, the cylindrical batteries are connected in series and/or in parallel by coupling cables to connection holes in the fixing caps 10 of each of the mounted cylindrical batteries, followed by performing a suitable wiring process.

As described above, embodiments of the welding-type fixing cap have sufficient mechanical strength and prevent leakage of electric current during a contact-resistance welding process, and, accordingly, is useful in manufacturing a cell module in which cylindrical batteries are connected in series and/or in parallel.

The embodiments described herein provide examples for the purpose of illustration only and are not intended to limit the scope, which should be understood to encompass equivalents and modifications apparent to those skilled in the art without departing from the spirit and scope thereof.

What is claimed is:

1. A welding-type fixing cap comprising:
a ring-shaped side wall;
a visor surface extending outward from one end of the side wall;
a welding lug formed on the visor surface and operable to be melted during a welding process; and
a cutting area formed in the side wall, and dimensioned and configured for discharging an internal gas,
wherein a line through a center point of the welding lug and normal to the side wall intersects at least a portion of a cutting area.

2. The welding-type fixing cap according to claim 1, wherein at least two welding lugs are formed on the visor surface distal to the side wall.

3. The welding-type fixing cap according to claim 1, wherein the welding lug is operable and configured for welding using a contact resistance welding.

4. The welding-type fixing cap according to claim 1, wherein a cutting groove is formed in the visor surface, which increases resistance between neighboring welding lugs.

5. The welding-type fixing cap according to claim 1, further comprising a welding lug-surrounding region formed on the visor surface and substantially centered above the welding lug, wherein the welding lug-surrounding region is thinner than the adjacent visor surface.

6. The welding-type fixing cap according to claim 1, wherein a gap between the cutting area and the visor surface is about 2 mm or less, and circumferential length of the cutting areas in the side wall comprise from about 40% to about 60% of the total circumferential length of the side wall.

7. The welding-type fixing cap according to claim 1, wherein an exterior common tangent line between a boundary surface of the cutting area and a boundary surface of the welding lug forms an angle of from about 20° to about 60° with a line normal to the visor surface passing through the center of the cutting area.

8. The welding-type fixing cap according to claim 1, further comprising a base wall closing the other end of the side wall.

9. The welding-type fixing cap according to claim 8, wherein a connection hole is formed in a central region of the base wall, dimensioned and configured to receive an external linear structure for coupling with a cylindrical structural body.

10. The welding-type fixing cap according to claim 9, wherein a screw thread is formed in an inner wall of the connection hole to couple the linear structure.

11. The welding-type fixing cap according to claim 1, wherein
two tangent lines are tangent to each of the cutting holes on the side wall and substantially normal to the visor surface,
two emission lines on the visor surface are normal to the side wall, each emission line intersecting a tangent line, and
the welding lug is formed between the two emission lines.

12. A cell module comprising:
a frame comprising a plurality of mounting holes formed therein; and
a cylindrical battery comprising a first end and a second end, and a fixing cap welded to each of the first end and the second end, wherein each fixing cap is coupled with a mounting hole,
wherein fixing cap comprises the welding-type fixing cap of any of claims 1-11.
